(19) United States
(12) Patent Application Publication
(10) Pub. No.: US 2014/0064577 A1
(43) Pub. Date: Mar. 6, 2014

(54) IMAGE PROCESSING DEVICE AND RECORDING MEDIUM STORING PROGRAM

(71) Applicant: Buffalo Inc., Nagoya-shi (JP)

(72) Inventors: Hayato Kato, Nagoya-shi (JP); Kenji Takahashi, Nagoya-shi (JP)

(73) Assignee: Buffalo Inc., Nagoya-shi (JP)

(21) Appl. No.: 14/011,058

(22) Filed: Aug. 27, 2013

(30) Foreign Application Priority Data
Aug. 29, 2012 (JP) 2012-188295

(51) Int. Cl. G06K 9/00

(52) U.S. Cl. CPC G06K 9/00288
USPC 382/118

(57) ABSTRACT

Image data in which persons are captured is accumulated in association with information indicating dates of taking the image data, the image data is subjected to person recognition processing for recognizing the captured persons, and image data in which a person of interest is captured is extracted. Actual age information of the person of interest for each piece of the extracted image data is obtained, and estimated age information of the person of interest which estimated age information is obtained by estimating the age of the captured person of interest from the image data is obtained. Age correcting information is generated on a basis of a result of statistical arithmetic operation on the actual age information calculated for each piece of the extracted image data and the estimated age information corresponding to each piece of the actual age information and estimated from the image data.

### CROSS REFERENCE TO RELATED APPLICATION

This application is based upon and claims the benefit of priority from Japanese Patent Application No. 2012-188295 filed on Aug. 29, 2012, the entire contents of which is incorporated herein by reference.

1. Field of the Disclosure

The present disclosure relates to an image processing device for processing image data in which a person is captured and a recording medium storing a program.

2. Related Art

Processing for recognizing a person captured in image data has recently been widely known as one process relating to the image data taken by a digital camera. For example, processing of face recognition is performed on image data taken by a digital camera. When a person is recognized from the image data, the name of the person is accumulated in association with the image data. This makes it possible to search for the image data from the name of the person.

There are techniques for improving recognition accuracy by retaining reference face images at a plurality of time points and selectively using a reference face image suitable for an age at a photographing time point for recognition.

However, the above technique may frequently cause errors in recognition between brothers and sisters in photographs taken in a home where the brothers and the sisters having faces closely resembling each other, for example. Specifically, suppose that there is image data taken in a year 2003 of the Christian era (hereinafter years will be denoted using the Christian era) in which an elder brother was three years old, that a younger brother was born in a next year of 2004, and that there is image data taken when the younger brother became three years old in 2007. In this case, when the faces of the brothers at the same age of three closely resemble each other, the face of the younger brother may be recognized as that of the elder brother, or although the image data in which the elder brother was photographed was taken in 2003 (although the younger brother was not born in 2003), the photographed elder brother may be recognized as the younger brother, due to errors in face recognition processing performed on a computer.

### SUMMARY

The present disclosure has been made in view of the above actual situation, and it is an object of the present disclosure to provide an image processing device and a recording medium storing a program that can reduce errors in recognition of persons on the basis of image data.

According to one exemplary embodiment, the disclosure is directed to an information processing apparatus that acquires a captured image and information indicating a date that the captured image was created; performs facial recognition processing on the captured image to identify a person in the captured image; extracts image data from the captured image corresponding to a portion of the captured image that includes at least a portion of a face of the person identified in the captured image; acquires a birth date of the person identified in the captured image; calculates an actual age of the person identified in the captured image by calculating a difference between the date the captured image was created and the birth date of the person identified in the captured image; obtains estimated age information of the person identified in the captured image based on the extracted image data; generates age correcting information indicating a difference between the actual age and the estimated age information; and determines whether a result of the facial recognition processing is correct based on the generated age correcting information.

### BRIEF DESCRIPTION OF DRAWINGS

FIG. 1 is a block diagram showing an example of configuration of an image processing device according to one aspect of an embodiment of the present disclosure;

FIG. 2A is a diagram of assistance in explaining an example of details of data retained by the image processing device according to one aspect of the embodiment of the present disclosure;

FIG. 2B is a diagram of assistance in explaining another example of details of data retained by the image processing device according to one aspect of the embodiment of the present disclosure;

FIG. 2C is a diagram of assistance in explaining yet another example of details of data retained by the image processing device according to one aspect of the embodiment of the present disclosure;

FIG. 3 is a functional block diagram of an example of the image processing device according to one aspect of the embodiment of the present disclosure;

FIG. 4 is a flowchart of an example of operation of the image processing device according to one aspect of the embodiment of the present disclosure; and

FIG. 5 is another flowchart of an example of operation in the image processing device according to one aspect of the embodiment of the present disclosure.

### DESCRIPTION OF THE DISCLOSURE

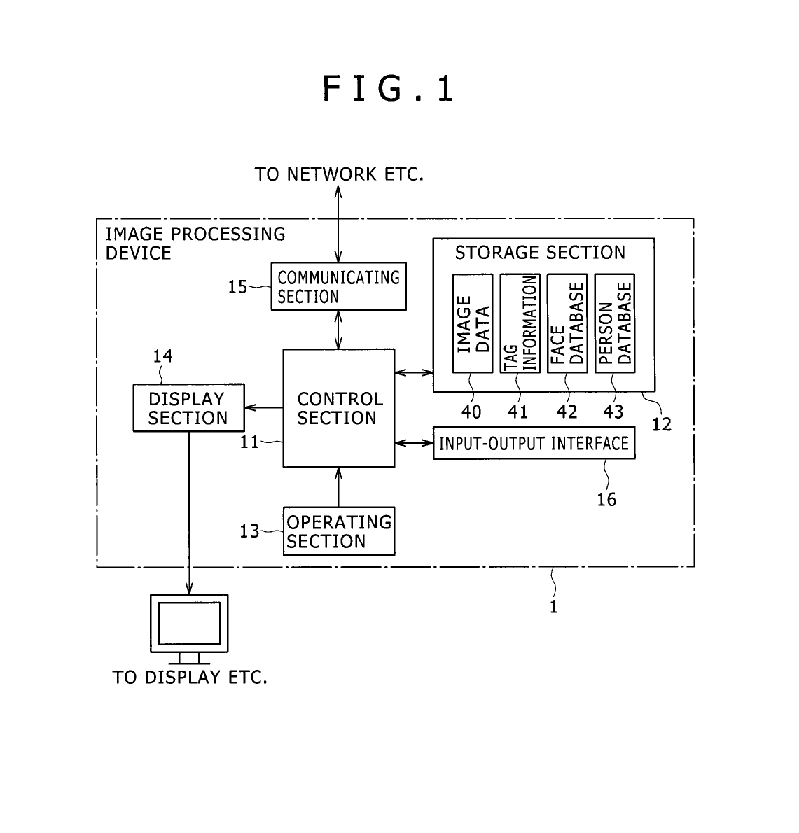

A preferred embodiment of the present disclosure will be described with reference to the drawings. As illustrated in FIG. 1, an image processing device 1 according to one aspect of the embodiment of the present disclosure includes a control section 11, a storage section 12, an operating section 13, a display section 14, a communicating section 15, and an input-output interface 16. The control section 11 is a program control device such as a CPU (Central Processing Unit) or the like. The control section 11 operates according to a program stored in the storage section 12.

Specifically, the control section 11 in one aspect of the present embodiment receives image data as an object of processing via the input-output interface 16, and accumulates and stores the image data in the storage section 12. The image data as an object of processing in one aspect of the present embodiment is image data representing an image taken by a digital camera or the like, and includes so-called Exif (Exchangeable Image File Format) information, which includes information on a date of taken image, camera identifying information identifying the camera that took the image, and the like.

The control section 11 in the present aspect subjects the image data accumulated in the storage section 12 to person recognition processing for recognizing a captured person, and extracts image data in which a person of interest who is separately determined is captured. The control section 11 obtains information on a photographing date for each piece of the extracted image data, and obtains the date of birth of the person of interest (suppose that the date of birth of the person of interest is retained in a person database to be described later).

The control section 11 obtains actual age information of the person of interest for each piece of the extracted image data by calculating a difference between the photographing date obtained for each piece of the extracted image data and the date of birth of the person of interest. In addition, the control section 11 obtains estimated age information by estimating the age of the person of interest captured in each piece of the image data by recognition processing on each piece of the extracted image data.

The control section 11 further performs a statistical arithmetic operation on the actual age information calculated for each piece of the extracted image data and the estimated age information that corresponds to each piece of the actual age information and which is estimated from the image data, and generates age correcting information indicating a difference between an actual age and an apparent age on the basis of a result of the statistical arithmetic operation. The control section 11 then determines whether a recognition result of the person recognition processing performed on the image data is correct or not, using the age correcting information. Details of the operation of the control section 11 will be described later.

The storage section 12 stores the program executed by the control section 11. This program may be provided in a state of being stored on a non-transitory computer-readable recording medium such as a DVD-ROM (Digital Versatile Disc Read Only Memory) or the like, and stored in the storage section 12. The program may also be distributed via a network or the like, and stored in the storage section 12.

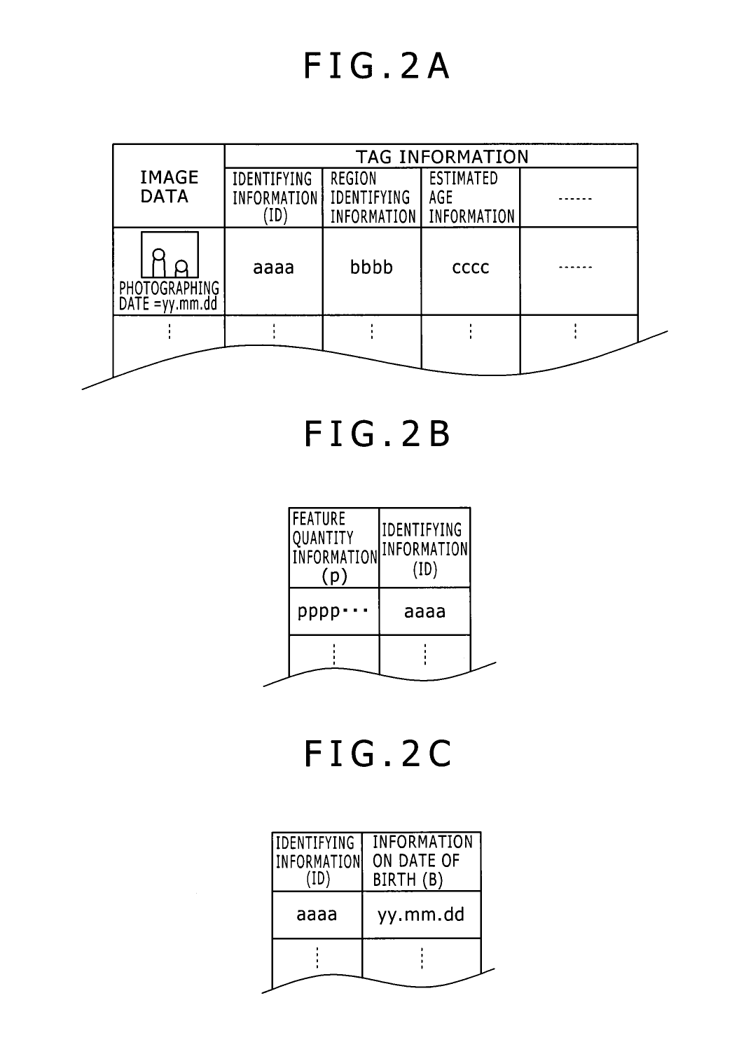

In the present aspect, as illustrated in FIG. 1 and FIG. 2A, image data 40 is accumulated and stored in association with tag information 41 in the storage section 12. Incidentally, the image data 40 may include Exif data. In addition, as illustrated in FIG. 1 and FIG. 2B, the storage section 12 stores a face database 42 including entries associating predetermined feature quantity information (P) relating the faces of persons and identifying information (ID) with each other for person recognition processing. The identifying information (ID) in this case is information identifying the persons, such as the names of the persons or the like. The storage section 12 further retains a person database 43 including entries associating the identifying information (ID) and information (B) on the dates of birth of the persons identified by the identifying information with each other as shown in FIG. 1 and FIG. 2C.

The operating section 13 may be for example a mouse, a keyboard, or the like, or may be an infrared input interface. In an example of the present aspect, the operating section 13 is an infrared input interface, and receives information indicating details of an indicating operation of a user, which information is transmitted by a remote control (not shown) that received the indicating operation of the user. The operating section 13 then outputs the received information indicating the details of the indicating operation to the control section 11.

The display section 14 is an interface for outputting an image to a built-in display or an external display such as a television device for home use or the like according to an instruction input from the control section 11. The communicating section 15 is for example a network interface. The communicating section 15 is connected to a network by wire or radio, and outputs information received via the network to the control section 11. In addition, the communicating section 15 receives the input of information to be transmitted via the network from the control section 11, and transmits the information via the network.

The input-output interface 16 is for example an SD card slot, a USB (Universal Serial Bus) interface, or the like. The input-output interface 16 reads image data 40 from an SD card, a USB memory, a USB hard disk drive, or the like connected to the input-output interface 16, and outputs the image data 40 to the control section 11, according to an instruction input from the control section 11, for example.

Details of processing of the control section 11 in the present aspect will next be described. The control section 11 in the present aspect performs processing of accumulating the image data 40, processing of displaying the image data 40, and processing of managing the image data 40. In addition, as a precondition for the management processing, the control section 11 performs person recognition processing and processing of determining whether a recognition result of the person recognition processing is correct or not.

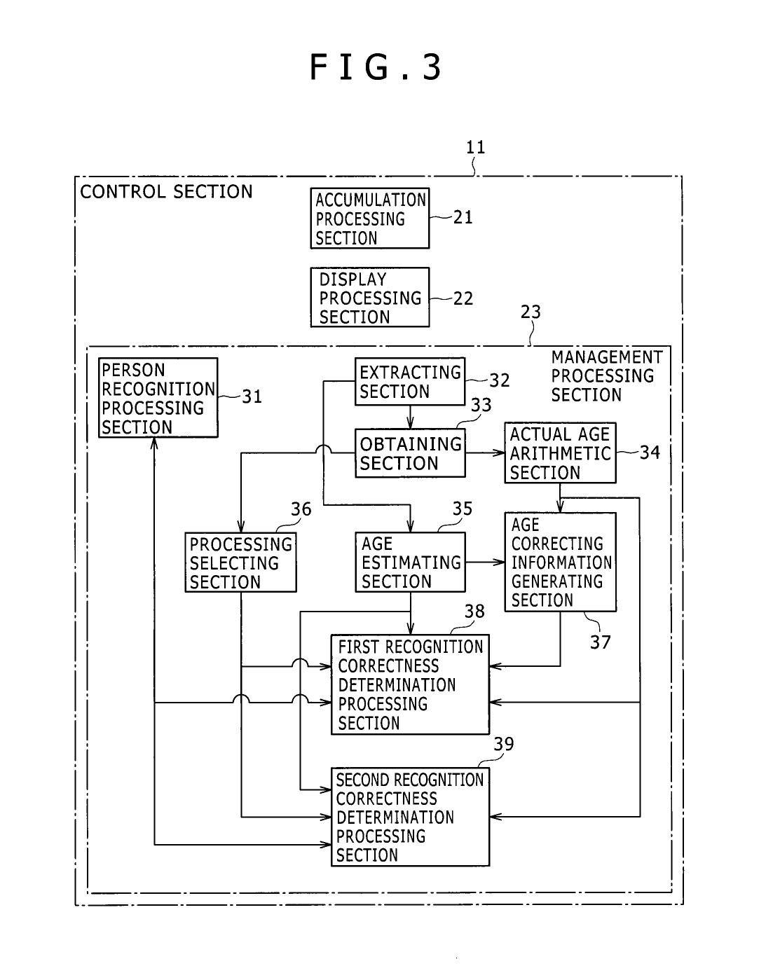

Specifically, as illustrated functionally in FIG. 3, the control section 11 in the present aspect includes an accumulation processing section 21, a display processing section 22, and a management processing section 23. The management processing section 23 further includes a person recognition processing section 31, an extracting section 32, an obtaining section 33, an actual age arithmetic section 34, an age estimating section 35, a processing selecting section 36, an age correcting information generating section 37, a first recognition correctness determination processing section 38, and a second recognition correctness determination processing section 39.

The accumulation processing section 21 receives an instruction to capture image data 40 from the operating section 13, and gives an instruction to read the image data 40 to the input-output interface 16. The accumulation processing section 21 then accumulates and stores the image data 40 read from the input-output interface 16 in the storage section 12.

The display processing section 22 reads image data 40 stored in the storage section 12, and outputs the image data 40 to the display section 14, according to an instruction input from the operating section 13, to make the built-in display or the external display such as the television device for home use or the like output an image represented by the image data 40. The display processing section 22 may also perform processing for selective display output of image data 40 including information specified by the user in Exif information, which image data is included in the image data 40 stored in the storage section 12.

The person recognition processing section 31 of the management processing section 23 selects image data yet to be set as an object of person recognition processing from the image data 40 stored in the storage section 12. The person recognition processing section 31 then performs person recognition processing on the selected image data 40. This person recognition processing identifies a region having the feature of the face of a person from the selected image data 40.

The person recognition processing section 31 then performs processing of identifying a person for each identified region. Specifically, the person recognition processing section 31 sequentially selects each region as a region of interest, and extracts a predetermined feature quantity (information indicating the feature of a face such as an interval between eyes or the like) relating to the face of a person included in the region of interest. The person recognition processing section 31 refers to the face database 42 stored in the storage section 12, and compares information on the feature quantity of each entry stored in the face database 42 with information on the extracted feature quantity.

When the person recognition processing section 31 finds an entry including information on a feature quantity coinciding with or similar to the information on the extracted feature quantity from the face database 42 as a result of the comparison, the person recognition processing section 31 further estimates the age of the captured person from information on the parts, contour, wrinkles of the face present within the region of interest, for example. This estimation is made on the basis of the image data 40 irrespective of the information on the photographing date and the date of birth, and can use a method disclosed in Y. H. Kwon and N. da Vitoria Lobo (1999), “Age Classification from Facial Images,” Computer Vision and Image Understanding Journal 74(1), pp. 1 to 21, for example.

When the person recognition processing section 31 thus finds an entry including information on a feature quantity coinciding with or similar to the information on the extracted feature quantity from the face database 42, the person recognition processing section 31 makes the storage section 12 retain identifying information included in the entry, region identifying information identifying the region of interest, and information indicating the above-described estimated age of the person (estimated age information) as one piece of tag information in association with the selected image data 40. It suffices for the region identifying information identifying the region of interest in this case to be coordinate information on two vertices on a diagonal line of a rectangular region when the region of interest is the rectangular region, for example.

When the person recognition processing section 31 does not find an entry including information on a feature quantity coinciding with or similar to the information on the extracted feature quantity from the face database 42, the person recognition processing section 31 may request the user to input information corresponding to identifying information such as the name of the person or the like. After the user inputs the identifying information to be associated with the information on the feature quantity where no entry including information on a feature quantity coinciding with or similar to the information on the extracted feature quantity is found from the face database 42, the person recognition processing section 31 adds and stores an entry associating the information on the feature quantity with the identifying information in the face database 42. In addition, at this time, the person recognition processing section 31 makes the storage section 12 retain the identifying information input by the user and the region information identifying the region of interest as one piece of tag information in association with the image data 40 from which the information on the feature quantity is extracted.

The extracting section 32 receives the input of identifying information of a person of interest determined by specification of the user, a predetermined condition, or the like. The extracting section 32 extracts image data 40 including the identifying information of the person of interest as tag information from the storage section 12. When the extracting section 32 cannot extract any piece of image data 40 (when there is no image data 40 associated with the identifying information of the person of interest, for example), the extracting section 32 may notify an error and interrupt the processing.

The obtaining section 33 obtains information Tt[i] (i is an index of each piece of the image data 40, and i=1, 2, . . . ) on the date of taking the image data 40 extracted in the extracting section 32 (each piece of the image data 40 when there are a plurality of pieces of image data 40 extracted by the extracting section 32). The obtaining section 33 also obtains information Tb on a date of birth associated with the identifying information of the person of interest from the person database 43 retained in the storage section 12.

The actual age arithmetic section 34 calculates actual age information of the person of interest at a time of imaging of each piece of the image data 40, for each piece of the image data 40 extracted by the extracting section 32, using each piece of the information Tt[i] (i=1, 2, . . . ) on the date of taking the image data 40 obtained by the obtaining section 33 and the information Tb on the date of birth. Specifically, the actual age arithmetic section 34 calculates and obtains the actual age information At[i]=Tt[i]−Tb of the person of interest for an ith piece of image data 40 whose date of taking the image data 40 is Tt[i].

The age estimating section 35 obtains a result of estimation from the image data 40 of the age of the person of interest captured in each piece of the image data 40, for each piece of the image data 40 extracted by the extracting section 32. Specifically, the age estimating section 35 obtains information Ae[i] on the result of estimation of the age (age estimation information) from the storage section 12, which information is associated with the identifying information of the person of interest, and which information is included in the tag information associated with the ith piece of image data (i=1, 2, . . . ) 40.

The processing selecting section 36 refers to the number N of pieces of image data 40 extracted by the extracting section 32, and checks whether the number N exceeds a predetermined threshold value nth. The processing selecting section 36 selects one of the first recognition correctness determination processing section 38 and the second recognition correctness determination processing section 39 according to whether the number N exceeds the threshold value nth. The processing selecting section 36 then instructs the selected first recognition correctness determination processing section 38 or the selected second recognition correctness determination processing section 39 to determine whether a result of recognition of the person of interest by person recognition processing is correct or not. As an example, when the number N exceeds the threshold value nth, the processing selecting section 36 selects the first recognition correctness determination processing section 38, and instructs the selected first recognition correctness determination processing section 38 to determine whether a result of recognition of the person of interest by person recognition processing is correct or not. When the number N does not exceed the threshold value nth, the processing selecting section 36 selects the second recognition correctness determination processing section 39, and instructs the selected second recognition correctness determination processing section 39 to determine whether a result of recognition of the person of interest by person recognition processing is correct or not.

The age correcting information generating section 37 generates age correcting information according to an instruction input from the first recognition correctness determination processing section 38. Specifically, the age correcting information generating section 37 reads the actual age information At[i] of the person of interest which information is calculated for the ith piece of image data (i=1, 2, . . . ) 40 and the information Ae[i] on the result of estimation of the age from the storage section 12. The age correcting information generating section 37 then generates age correcting information indicating a difference between the actual age and the apparent age on the basis of a result of statistical arithmetic operation on the actual age information At[i] and the information Ae[i] on the result of estimation of the age from the image data 40.

As an example, the age correcting information generating section 37 calculates correlation coefficients between the actual age information At[i] for each piece of the image data 40 and the information Ae[i] on the result of estimation of the age from the image data 40 as age correcting information from the set of the actual age information At[i] for each piece of the image data 40 and the information Ae[i] on the result of estimation of the age from the image data 40. The correlation coefficients as age correcting information in this case are α and β when the estimation result Ae in relation to the actual age information At is assumed to be expressed by a linear expression, Ae=α·At+β, for example. Specifically, it suffices to determine α and β by a method of least squares. The age correcting information generating section 37 outputs the age correcting information obtained as described above to the first recognition correctness determination processing section 38.

When the first recognition correctness determination processing section 38 receives an instruction to determine whether a result of recognition of the person of interest by person recognition processing is correct or not from the processing selecting section 36, the first recognition correctness determination processing section 38 instructs the age correcting information generating section 37 to generate age correcting information. The first recognition correctness determination processing section 38 then receives the input of the age correcting information from the age correcting information generating section 37.

In the following, for purposes of illustration, suppose that, as an example, the correlation coefficients α and β when there is assumed to be a relation expressed by the linear expression Ae=α·At+β between the actual age information At and the estimation result Ae are the age correcting information.

When the first recognition correctness determination processing section 38 is given the actual age information At[i], the first recognition correctness determination processing section 38 sets α·At[i]+β to be calculated using these correlation coefficients as an assumed estimated value Aee[i]. That is, Aee[i]=α·At[i]+β. The first recognition correctness determination processing section 38 then obtains the absolute value |Ae[i]−Aee[i]|=|Ae[i]−α·At[i]+β| of a difference between the assumed estimated value Aee[i] and the information Ae[i] on the result of estimation of the age which information corresponds to the actual age information At[i]. Incidentally, |*| denotes that the absolute value of * is calculated.

When the absolute value |Ae[i]−α·At[i]+η| obtained in this case exceeds a predetermined threshold value, the first recognition correctness determination processing section 38 determines that the result of recognition of the person of interest for the ith piece of image data 40 is incorrect. Further, the first recognition correctness determination processing section 38 also determines that the result of recognition of the person of interest for the ith piece of image data 40 is incorrect when the actual age information At[i] is negative. When the actual age information At[i] is not negative and the absolute value |Ae[i]−α·At[i]+δ| does not exceed the predetermined threshold value, the first recognition correctness determination processing section 38 determines that the result of recognition of the person of interest for the ith piece of image data 40 is not incorrect.

Further, when the first recognition correctness determination processing section 38 determines that the result of recognition of the person of interest for the ith piece of image data 40 is incorrect, the first recognition correctness determination processing section 38 finds tag information including the identifying information of the person of interest as processing object tag information, which tag information is included in the tag information recorded in the storage section 12 in association with the ith piece of image data 40. The first recognition correctness determination processing section 38 extracts region identifying information from the processing object tag information, stores the region identifying information, and deletes the processing object tag information.

The first recognition correctness determination processing section 38 then outputs the region identifying information to the person recognition processing section 31 to make the person recognition processing section 31 set the region identified by the region identifying information as a region of interest and recognize the person included in the region of interest. In this case, the first recognition correctness determination processing section 38 also outputs the identifying information of the person of interest to the person recognition processing section 31, and gives an instruction to the effect that the person to be recognized is not the person of interest.

The person recognition processing section 31 extracts a predetermined feature quantity (information indicating the feature of a face such as an interval between eyes or the like) relating to the face of the person within the region of interest. The person recognition processing section 31 refers to entries that do not include the identifying information input from the first recognition correctness determination processing section 38 in the face database 42 stored in the storage section 12, and compares information on the feature quantity of each entry referred to with information on the extracted feature quantity.

When the person recognition processing section 31 finds an entry including information on a feature quantity coinciding with or similar to the information on the extracted feature quantity from the face database 42 as a result of the comparison, the person recognition processing section 31 makes the storage section 12 retain identifying information included in the entry as one piece of tag information in association with the selected image data 40. At this time, the person recognition processing section 31 estimates the age of the captured person from information on the parts, contour, wrinkles of the face present within the region of interest, for example.

When the person recognition processing section 31 finds the entry including the information on the feature quantity coinciding with or similar to the information on the extracted feature quantity from the face database 42, the person recognition processing section 31 makes the storage section 12 retain the identifying information included in the entry, the region information identifying the region of interest, and information indicating the above-described estimated age of the person (estimated age information) as one piece of tag information in association with the selected image data 40.

When the person recognition processing section 31 does not find an entry including information on a feature quantity coinciding with or similar to the information on the extracted feature quantity from the face database 42, the person recognition processing section 31 may request the user to input information corresponding to identifying information such as the name of the person or the like. After the user inputs the identifying information to be associated with the information on the feature quantity where no entry including information on a feature quantity coinciding with or similar to the information on the extracted feature quantity is found from the face database 42, the person recognition processing section 31 adds and stores an entry associating the information on the feature quantity with the identifying information in the face database 42. In addition, at this time, the person recognition processing section 31 makes the storage section 12 retain the identifying information input by the user and the region information identifying the region of interest as one piece of tag information in association with the image data 40 from which the information on the feature quantity is extracted.

When the second recognition correctness determination processing section 39 receives an instruction to determine whether a result of recognition of the person of interest by person recognition processing is correct or not from the processing selecting section 36, the second recognition correctness determination processing section 39 checks whether there is negative actual age information At[i] (i=1, 2, . . . ). When actual age information At[j] is negative, for example, the second recognition correctness determination processing section 39 determines that a result of recognition of the person of interest for a jth piece of image data 40 is incorrect.

Further, when the second recognition correctness determination processing section 39 determines in this case that the result of recognition of the person of interest for the jth piece of image data 40 is incorrect, the second recognition correctness determination processing section 39 finds tag information including the identifying information of the person of interest as processing object tag information, which tag information is included in the tag information recorded in the storage section 12 in association with the jth piece of image data 40. The second recognition correctness determination processing section 39 extracts region identifying information from the processing object tag information, stores the region identifying information, and deletes the processing object tag information.

The second recognition correctness determination processing section 39 then outputs the region identifying information to the person recognition processing section 31 to make the person recognition processing section 31 set the region identified by the region identifying information as a region of interest and recognize the person included in the region of interest. In this case, the second recognition correctness determination processing section 39 also outputs the identifying information of the person of interest to the person recognition processing section 31, and gives an instruction to the effect that the person to be recognized is not the person of interest.

The person recognition processing section 31 operates in a similar manner to the case where the person recognition processing section 31 receives the same instruction from the first recognition correctness determination processing section 38. Specifically, the person recognition processing section 31 extracts a predetermined feature quantity (information indicating the feature of a face such as an interval between eyes or the like) relating to the face of the person within the region of interest. The person recognition processing section 31 refers to entries that do not include the identifying information of the person of interest which identifying information is input from the second recognition correctness determination processing section 39 in the face database 42 stored in the storage section 12, and compares information on the feature quantity of each entry referred to with information on the extracted feature quantity.

When the person recognition processing section 31 finds an entry including information on a feature quantity coinciding with or similar to the information on the extracted feature quantity from the face database 42 as a result of the comparison, the person recognition processing section 31 makes the storage section 12 retain identifying information included in the entry as one piece of tag information in association with the selected image data 40. At this time, the person recognition processing section 31 estimates the age of the captured person from information on the parts, contour, wrinkles of the face present within the region of interest, for example.

When the person recognition processing section 31 finds the entry including the information on the feature quantity coinciding with or similar to the information on the extracted feature quantity from the face database 42, the person recognition processing section 31 makes the storage section 12 retain the identifying information included in the entry, the region information identifying the region of interest, and information indicating the above-described estimated age of the person (estimated age information) as one piece of tag information in association with the selected image data 40.

When the person recognition processing section 31 does not find an entry including information on a feature quantity coinciding with or similar to the information on the extracted feature quantity from the face database 42, the person recognition processing section 31 may request the user to input information corresponding to identifying information such as the name of the person or the like. After the user inputs the identifying information to be associated with the information on the feature quantity for which no entry including information on a coinciding or similar feature quantity is found from the face database 42, the person recognition processing section 31 adds and stores an entry associating the information on the feature quantity with the identifying information in the face database 42. In addition, at this time, the person recognition processing section 31 makes the storage section 12 retain the identifying information input by the user and the region information identifying the region of interest as one piece of tag information in association with the image data 40 from which the information on the feature quantity is extracted.

One aspect of an embodiment of the present disclosure basically has the above configuration, and operates as follows. In the following example, suppose that the image data 40 of photographs taken in a home where brothers having faces closely resembling each other live is accumulated. Also suppose in this case that the elder brother was born in 2000 and that the younger brother was born in 2004.

In this case, when the user connects a recording medium on which the image data 40 of photographs taken from 2000 to 2012 is recorded to the input-output interface 16, and gives a reading instruction, the image processing device 1 according to one aspect of the present embodiment accumulates and stores the image data 40 read by the input-output interface 16 in the storage section 12. The image data 40 includes Exif information such as information of date of taking the image data 40 and the like.

The image processing device 1 selects image data 40 yet to be set as an object of person recognition processing from the image data 40 stored in the storage section 12, and performs person recognition processing on the selected image data 40. Suppose in this case that the feature quantities of the faces of the respective brothers around 2007, for example, are recorded in the face database 42 in association with the identifying information of the respective brothers. That is, suppose that the feature quantity of the face of the elder brother around an age of seven and the feature quantity of the face of the younger brother around an age of three are recorded in the face database 42.

In this case, the image processing device 1 may misidentify the image data 40 of the elder brother at an age of three in 2003, for example, as that of the younger brother from the feature quantity of the face of the elder brother. That is, the image processing device 1 may associate the identifying information identifying the younger brother as tag information with the image data 40 whose date of taking the image data 40 is 2003 and in which the elder brother is captured. In addition, the image processing device 1 may misidentify the image data 40 of the elder brother at an age of five in 2005, for example, as that of the younger brother from the feature quantity of the face of the elder brother. That is, the image processing device 1 may associate the identifying information identifying the younger brother as tag information with the image data 40 whose date of taking the image data 40 is 2005 and in which the elder brother is captured. Incidentally, suppose that age estimation processing has been performed on the images of the face of the elder brother in this case, and that the image processing device 1 has estimated the face of the elder brother at the time of the age of three to be the face of a person at an age of five, and estimated the face of the elder brother at the time of the age of five to be the face of a person at an age of six. Then, these pieces of image data 40 are associated with tag information including the identifying information identifying the younger brother and information indicating the “age of five” and the “age of six,” respectively, as age estimation information.

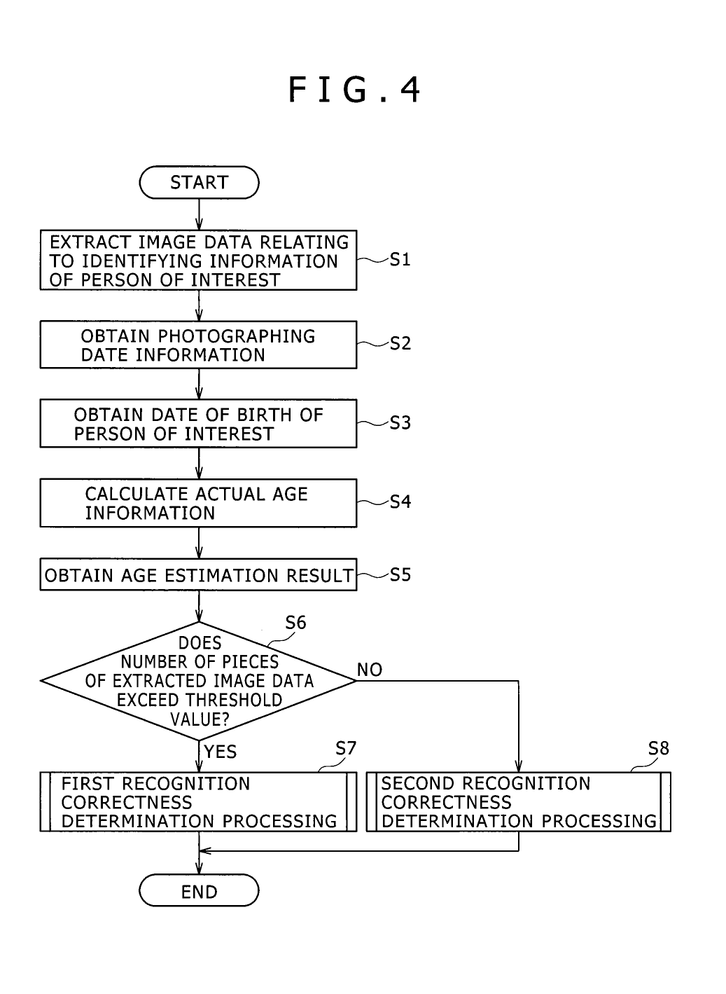

Next, the image processing device 1 for example sets a person recognized from the newly accumulated image data as a person of interest. In this case, the younger brother is set as a person of interest. As illustrated in FIG. 4, the image processing device 1 then extracts image data including the identifying information of the person of interest as tag information (S1). Suppose in this case that image data Di (i=1, 2, . . . , N) corresponding to each of N photographs is found.

The image processing device 1 obtains information Tt[i] on the date of taking each piece of image data Di (S2). The image processing device 1 also obtains information Tb on a date of birth recorded in association with the identifying information of the person of interest (S3). The image processing device 1 then calculates actual age information At[i]=Tt[i]−Tb of the person of interest at a time of imaging of each piece of image data Di (S4). For example, for the image data D1 (i=1) illustrated earlier in which the elder brother was three years old in 2003 and is misidentified as the younger brother, Actual Age Information At[1]=2003−2004=−1. Suppose in this case that only the years included in the information on the photographing date and the date of birth are used. Of course, the aspect of the present embodiment is not limited to this. For example, the date of taking the image data and the date of birth may be expressed using elapsed days from a predetermined date and time in the past to perform this calculation. In addition, for the image data D2 (i=2) in which the elder brother was five years old in 2005 and is misidentified as the younger brother, Actual Age Information At[2]=2005−2004=1.

In addition, the image processing device 1 obtains information Ae[i] on an age estimation result associated with the identifying information of the person of interest, the information Ae[i] on the age estimation result being included in the tag information associated with each of the image data Di (S5). In the above example, Ae[1] =5, and Ae[2]=6.

The image processing device 1 next determines whether the number N of pieces of image data Di exceeds a predetermined threshold value nth (S6). When the number N of pieces of image data Di exceeds the predetermined threshold value nth, the image processing device 1 performs first recognition correctness determination processing (S7). When the number N of pieces of image data Di does not exceed the predetermined threshold value nth in step S6, the image processing device 1 performs second recognition correctness determination processing (S8).

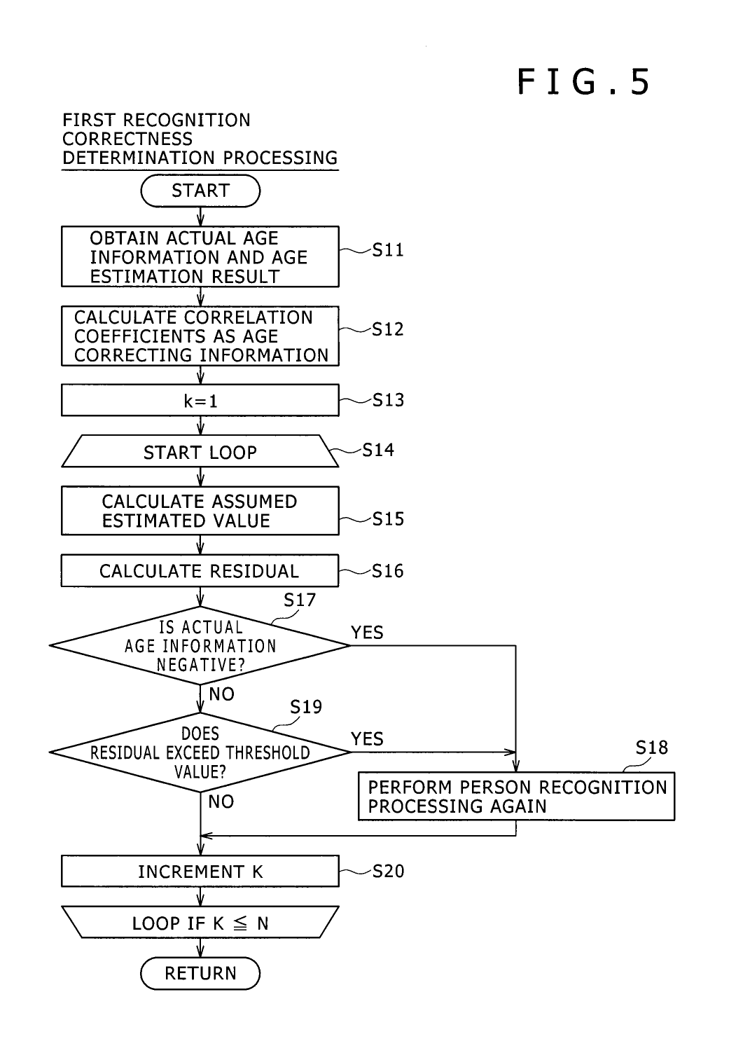

Specifically, in the first recognition correctness determination processing of step S7, age correcting information is first generated, as illustrated in FIG. 5. Specifically, the image processing device 1 obtains the actual age information At[i] of the person of interest which actual age information At[i] is calculated in step S4 and the information Ae[i] on the age estimation result obtained in step S5 for each of the image data Di (i=1, 2, . . . ) extracted in step S1 (S11).

The image processing device 1 calculates correlation coefficients between the actual age information At[i] for each piece of the image data Di and the information Ae[i] on the result of age estimation from the image data as age correcting information from the set of the actual age information At[i] for each piece of the image data Di and the information Ae[i] on the result of age estimation from the image data (S12). An example of the age correcting information is α and β when the information Ae on the age estimation result is assumed to be expressed by α·At+β using the actual age information, as already illustrated. Specifically, these correlation coefficients are determined by a method of least squares. A relation between the actual age information and the age estimation result is thereby estimated. As an example, when the foregoing younger brother is always recognized to be one year older than the actual age, α is roughly “1,” and βis+1.

The image processing device 1 resets a variable k to “1” (S13), and obtains an assumed estimated value using the actual age information At[k] of image data Dk and the age correcting information calculated in step S13 (S15). Specifically, the image processing device 1 obtains the assumed estimated value Aee[k]=α·At[k]+β using the foregoing α and β. The image processing device 1 obtains the absolute value |Ae[k]−Aee[k]|=|Ae[k]−α·At[k]+β| of a difference between the assumed estimated value Aee[k] and the information Ae[k] on the age estimation result corresponding to the actual age information At[k] (calculation of a residual: S16).

The image processing device 1 checks whether the actual age information At[k] is negative or not (S17). When the actual age information At[k] is negative (Yes), the image processing device 1 determines that a result of recognition of the person of interest “younger brother” of the image data Dk is incorrect, and performs person recognition processing again (S18). In this step S18, because it is determined that the person recognized as the “younger brother” is not the “younger brother” in the image data Dk, the person is recognized as a person other than the “younger brother” by recognizing the person again. The processing of FIG. 4 may be separately performed for this person (person other than the “younger brother”).

When the actual age information At[k] is not negative in step S17, in contrast, the image processing device 1 determines whether the absolute value |Ae[k]−α·At[k]+β| of the difference which absolute value is obtained in step S16 exceeds a predetermined threshold value θ (S19).

In the example of the foregoing brothers, for the image data D1 of the elder brother at the age of three in 2003 and the image data D2 of the elder brother at the age of five in 2005 (i=1, 2), Aee[1]=α·At[1]+β=1·(−1)+1=0, and Aee[2]=α·At[2]+β=1·1+1=2 (suppose that α and β are both 1). The actual age information includes a negative value because the elder brother is misidentified as the younger brother, and is thus different from the actual ages of the elder brother.

Because the actual age information At[1] is negative, the image processing device 1 determines that a result of recognition of the “younger brother” is incorrect for the image data D1, and performs person recognition processing again.

In contrast, the actual age information At[2] is not negative, and the information Ae[2] on the age estimation result is estimated to be “6” in the above example. Therefore the absolute value |Ae[2]−Aee[2]| of the difference between the assumed estimated value Aee[2] and the information Ae[2] on the age estimation result is “4.” When the threshold value θ is set at “3,” for example, it is determined in step S19 that the absolute values of the above-described differences both exceed the threshold value θ.

When the absolute value of the difference exceeds the threshold value θ in step S19 (Yes), the image processing device 1 determines that the result of recognition of the person of interest “younger brother” of the image data Dk is incorrect, and proceeds to step S18 to perform person recognition processing again.

When the absolute value of the difference does not exceed the threshold value θ in step S19, the image processing device 1 increments k by “1” (S20), and repeats the processing from step S14 when k is equal to or less than N (loop). When k is larger than N, the image processing device 1 ends the processing.

In the present example, for image data D3 (i=3) obtained by photographing the younger brother in 2007, for example, At[3]=3. In addition, suppose that a result of age estimation from the image data D3 is “5” (Ae[3]=5). Using the foregoing α and β, the assumed estimated value Aee[k]=α·At[k]+β is Aee[3]=α·At[3]+β=1·3+1=4. Hence, the absolute value |Ae[3]−Aee[3]| of the above-described difference is “1.” When the threshold value θ is set at “3,” it is not determined in step S19 that the recognition result is incorrect (incidentally, because the actual age information At[3] is not negative either, it is not determined in step S17 that the recognition result is incorrect). Incidentally, the threshold value θ may be changed according to elapsed days and time from the date of birth of the person of interest to the date of taking the image data set as an object of the processing. For example, the threshold value θ may be increased as the number of elapsed days from the date of birth increases, for example. In addition, the threshold value θ may be held constant after the number of elapsed days exceeds a predetermined value.

Meanwhile, the image processing device 1 performing the second recognition correctness determination processing in step S8 of FIG. 4 determines whether the actual age information At[i] calculated in step S4 includes negative actual age information At[i] (i=1, 2, . . . ). When actual age information At[j] is negative, for example, the image processing device 1 determines that a result of recognition of the person of interest for a jth image data Dj is incorrect. In the above-described case, for the image data D1 of the elder brother at the age of three in 2003, the actual age information At[1] is negative, and it is therefore determined that the recognition result is incorrect. Also in this step, the image processing device 1 may perform person recognition processing again for the image data for which it is determined that the recognition result is incorrect (as in step S18 described above).

Specifically, when performing person recognition processing again for ith image data Di, the image processing device 1 operates as follows. The image processing device 1 deletes tag information including the identifying information misidentifying the person of interest, which tag information is included in tag information recorded in the storage section 12 in association with the ith image data Di. In addition, the image processing device 1 performs the processing of recognizing the person within a region from the ith image data Di in which region the face misidentified as that of the person of interest is captured (region as an object of re-recognition). At this time, using the identifying information identifying the person of interest, the image processing device 1 compares a predetermined feature quantity relating to the face of the person within the region with information on feature quantities in entries not including the identifying information of the person of interest in the face database 42 stored in the storage section 12.

When the image processing device 1 finds an entry including information on a feature quantity that coincides with or is similar to information on the extracted feature quantity and which is not associated with the identifying information of the person of interest from the face database 42 as a result of the comparison, the image processing device 1 makes the storage section 12 retain identifying information included in the entry as one piece of tag information in association with the selected image data Di. At this time, the person recognition processing section 31 estimates the age of the captured person from information on the parts, contour, wrinkles of the face present within the region of interest, for example.

In the example of the foregoing brothers, the feature quantities of the faces of the brothers are similar to each other. It is therefore determined that except for the younger brother as the person of interest, the feature quantity associated with the identifying information of the elder brother is similar to the feature quantity of the face within the region as the object of the re-recognition. That is, the identifying information of the elder brother is highly likely to be associated with the image data D1 of the elder brother at the age of three in 2003 and the image data D2 of the elder brother at the age of five in 2005 (i=1, 2) by thus performing person recognition processing again.

The image processing device 1 thus sets tag information including the identifying information identifying the person photographed in the image data Di. Then, according to an instruction input from the operating section 13, the image processing device 1 for example selects and reads the image data Di of the photographs in which the younger brother is captured (image data associated with the tag information including the identifying information identifying the younger brother), and makes an external display or a television device for home use output the images represented by the image data Di.

Incidentally, the processing in the age correcting information generating section 37 is not limited to that described thus far. For example, the age correcting information generating section 37 may generate age correcting information indicating a difference between an actual age and an apparent age on the basis of a result of statistical arithmetic operation on estimated age information obtained by excluding estimated age information judged to be outliers from the estimated age information of a person of interest which information is estimated from each of the extracted image data 40 and the actual age information calculated for each piece of the extracted image data.

Specifically, the age correcting information generating section 37 reads the actual age information At[i] of the person of interest which information is calculated for ith image data Di (i=1, 2, . . . ) and information Ae[i] on an age estimation result from the storage section 12. The age correcting information generating section 37 then calculates temporary correlation coefficients from the set of the actual age information At[i] for each piece of the image data Di and the information Ae[i] on the result of age estimation from the image data. The temporary correlation coefficients in this case are for example αp and βp when the estimation result Ae in relation to the actual age information At is assumed to be expressed by a linear expression, Ae=αp·At+βp, for example. Specifically, it suffices to determine these temporary correlation coefficients by a method of least squares.

The age correcting information generating section 37 sets αp·At[i]+βp calculated using these temporary correlation coefficients as a temporary estimated value Ap[i] when the actual age information At[i] is given. That is, Ap[i]=αp·At[i]+βp is set. The age correcting information generating section 37 then obtains a difference (residual) R[i]=Ae[i]−Ap[i] between the temporary estimated value Ap[i] and the information Ae[i] on the age estimation result corresponding to the actual age information At[i]. The age correcting information generating section 37 also calculates a standard deviation σ of the residual R[i].

The age correcting information generating section 37 determines that of the information Ae[i] on the age estimation results, the information Ae[i] on the age estimation result such that a value obtained by dividing the information Ae[i] on the age estimation result by the standard deviation σ of the residual exceeds a predetermined threshold value is an outlier. In this case, the threshold value may be “2” or “3,” for example. The age correcting information generating section 37 generates age correcting information indicating a difference between an actual age and an apparent age on the basis of a result of statistical arithmetic operation on the information Ae[i] on the age estimation results obtained by excluding the information Ae[i] on the age estimation results judged to be outliers and the actual age information At[i] of the person of interest.

As an example, the age correcting information generating section 37 excludes information Ae[j] on an age estimation result judged to be an outlier and actual age information At[j] corresponding to the information Ae[j] on the age estimation result (corresponding to image data Dj), and determines, by a method of least squares, α and β when the estimation result Ae in relation to the actual age information At is assumed to be expressed by a linear expression, Ae=α·At+β.

For example, when image data Di for i=1, 2, . . . 5 is extracted, and information Ae[1] and Ae[3] on age estimation results corresponding to the image data D1 and D3 for i=1, 3 is judged to be outliers, the age correcting information generating section 37 excludes these pieces of information Ae[1] and Ae[3] on the age estimation results and actual age information At[1] and At[3] corresponding to these pieces of information Ae[1] and Ae[3] on the age estimation results, and determines α and β when the estimation result Ae is assumed to be expressed by a linear expression, Ae=α·At+β, from regression analysis of remaining actual age information At[2], At[4], and At[5] and information Ae[2], Ae[4], and Ae[5] on age estimation results corresponding to these pieces of actual age information At[2], At[4], and At[5].

In the present embodiment, the age correcting information generating section 37 uses regression analysis when generating age correcting information, but is not limited to this. For example, the age correcting information generating section 37 may consider a scatter diagram of age estimation results Ae[i] in relation to actual age information At[i], and generate age correcting information by principal component analysis in the scatter diagram or the like.

Further, the description thus far has been made of a case where information on a date of taking the image data 40 can be obtained from information associated with image data 40, such as Exif data or the like. However, even in cases where information on a date of taking the image data cannot be obtained immediately as in a case of the scan data of a photograph, processing by the image processing device 1 according to the present embodiment can be performed when information on a date of taking the image data can be obtained by some process.

For example, when date information is imprinted (when date information is imprinted as an image in a photograph), this date information may be read by OCR (Optical Character Recognition) and used. In addition, date information is described on the back of a photograph compliant with an APS (Advanced Photo System) standard, and therefore the date information may be read by OCR and used. In addition, when input of information on the date of taking a photograph can be received from the user, the information on the date of taking a photograph may be used.

In addition, in one aspect of the present embodiment described above, information on dates of taking the photograph is included as tag information 41 associated with image data 40. The data of time of taking the photograph in ordinary Exif information is often data including even hours, minutes, and seconds. Therefore, in the present embodiment, only data on dates of taking the photograph may be captured into the image processing device 1 with data on hours, minutes, and seconds omitted from the data of time of taking the photograph including even hours, minutes, and seconds, or the data of time of taking the photograph may be captured as tag information 41 as it is.

The image processing device according to the present embodiment can reduce errors in recognition of persons on the basis of image data.

In the above description, the storage section 12 constitutes accumulating section and person database retaining section. The person recognition processing section 31 and the extracting section 32 constitute extracting section. The obtaining section 33 constitutes obtaining section. The actual age arithmetic section 34 constitutes arithmetic section. The age estimating section 35 constitutes estimating section. The processing selecting section 36 constitutes determining section. The age correcting information generating section 37 constitutes correcting information generating section. The first recognition correctness determination processing section 38 performs first recognition correctness determination processing. The second recognition correctness determination processing section 39 performs second recognition correctness determination processing.

It should be understood by those skilled in the art that various modifications, combinations, sub-combinations and alterations may occur depending on design requirements and other factors insofar as they are within the scope of the appended claims or the equivalents thereof.

For example, in the foregoing aspect, the image processing device 1 is formed by a plurality of hardware elements. However, part of operation of the hardware elements can also be realized by operation of a program by the control section 11 or the like.

What is claimed is:

1. An image processing device comprising:
circuitry configured to
acquire a captured image and information indicating a date that the captured image was created;
perform facial recognition processing on the captured image to identify a person in the captured image;
extract image data from the captured image corresponding to a portion of the captured image that includes at least a portion of a face of the person identified in the captured image;
acquire a birth date of the person identified in the captured image;
calculate an actual age of the person identified in the captured image by calculating a difference between the date the captured image was created and the birth date of the person identified in the captured image;
obtain estimated age information of the person identified in the captured image based on the extracted image data; and
generate age correcting information indicating a difference between the actual age and the estimated age information; and
determine whether a result of the facial recognition processing is correct based on the generated age correcting information.

2. The image processing device according to claim 1, wherein the circuitry is configured to obtain the estimated age information of the person identified in the captured image by excluding estimated age information determined to be an outlier from the estimated age information of the person identified in the captured image.

3. The image processing device according to claim 1, further comprising:
accumulating section that accumulates the captured images and the information indicating dates that the captured images were created; and
person database retaining section that stores birth dates of the persons identified in the captured images,
and wherein the circuitry acquire the birth date of the person identified in the captured image from the person database retaining section.

4. An information processing apparatus, comprising:
circuitry configured to
acquire a plurality of captured images and information indicating a date that each of the plurality of captured images was created;
perform facial recognition processing on each of the plurality of captured images to identify a person in each of the plurality of captured images;
extract image data from each of the plurality of captured images corresponding to a portion of each of the plurality of captured images that include at least a portion of a face of the person identified in each of the plurality of captured images;
acquire a birth date of the person identified in each of the plurality of captured images;
calculate an actual age of the person identified in each of the plurality of captured image by calculating a difference between the date each of the captured images were created and the birth date of the person identified in each of the plurality of captured images;
obtain estimated age information of the person identified in each of the plurality of captured images based on the extracted image data from each of the plurality of captured images;
determines, based on whether a number of pieces of the extracted image data satisfies a predetermined condition, whether to
perform first recognition correctness determination processing by generating age correcting information indicating a difference between the actual age and the estimated age for each of the plurality of captured images, and determine whether a result of the facial recognition processing is correct based on the generated age correcting information, or
perform second recognition correctness determination processing for determining whether the result of the facial recognition process is correct based on the calculated actual age.

5. A non-transitory computer-readable medium including computer-program instructions, which when executed by an information processing apparatus, cause the information processing apparatus to:
acquire a captured image and information indicating a date that the captured image was created;
perform facial recognition processing on the captured image to identify a person in the captured image;
extract image data from the captured image corresponding to a portion of the captured image that includes at least a portion of a face of the person identified in the captured image;
acquire a birth date of the person identified in the captured image;
calculate an actual age of the person identified in the captured image by calculating a difference between the date the captured image was created and the birth date of the person identified in the captured image;
obtain estimated age information of the person identified in the captured image based on the extracted image data; and
generate age correcting information indicating a difference between the actual age and the estimated age information; and
determine whether a result of the facial recognition processing is correct based on the generated age correcting information.
